(19) United States
(12) Patent Application Publication
(10) Pub. No.: US 2026/0246162 A1
(43) Pub. Date: Aug. 20, 2026

(54) ELECTRIC WIRE WITH TERMINAL

(71) Applicants: AUTONETWORKS TECHNOLOGIES, LTD., Mie (JP); SUMITOMO WIRING SYSTEMS, LTD., Mie (JP); SUMITOMO ELECTRIC INDUSTRIES, LTD., Osaka (JP)

(72) Inventors: Yuji KAWATA, Osaka (JP); Yuhei YAMAMOTO, Osaka (JP); Kenji MIYAMOTO, Osaka (JP)

(21) Appl. No.: 19/165,146

(22) PCT Filed: Mar. 4, 2024
(86) PCT No.: PCT/JP2024/008013

§ 371 Date: Sep. 15, 2025

(30) Foreign Application Priority Data
Mar. 23, 2023 (JP) 2023-046506

(51) Int. Cl. H01R 4/02; H01R 4/58

(52) U.S. Cl. CPC H01R 4/023; H01R 4/58

(57) ABSTRACT

A electric wire with a terminal is an electric wire with a terminal to which the electric wire is joined, and includes a terminal including a wire joint portion and the electric wire joined to the wire joint portion. A first surface and a second surface located at different heights are formed at different positions in a width direction on a surface of the wire joint portion facing the electric wire. The electric wire is joined to the first surface, the second surface, and at least a portion of a region between the first surface and the second surface of the wire joint portion.

### TECHNICAL FIELD

The present disclosure relates to an electric wire with a terminal.

### BACKGROUND

Regarding joining between a terminal and an electric wire, an electric wire with a terminal is disclosed in JP 2009-259702 A, for example. JP 2009-259702 A discloses an electric wire with a terminal in which a widthwise end portion of a joint between the electric wire and the terminal is located at a position higher than an intermediate portion of the joint. In the electric wire with a terminal disclosed in JP 2009-259702 A, a terminal fitting and a core wire housed inside the terminal fitting are welded by ultrasonic welding.

### PRIOR ART DOCUMENT

### Patent Document

Patent Document 1: JP 2009-259702 A.

### SUMMARY OF THE INVENTION

### Problems to Be Solved

In recent years, there are demands for downsized components used in automobiles in order to save space. For example, if a terminal is downsized, an electric wire is joined to the terminal having a joint portion with a small joint width. At this time, a sufficient joined area is unlikely to be secured in the joint portion of the terminal. If the joined area between the terminal and the electric wire is small, the tensile strength of the joined portion between the terminal and the electric wire becomes low. Therefore, there are demands for an electric wire with a terminal that can have a high tensile strength.

Under the above circumstances, an object of the present disclosure is to provide an electric wire with a terminal that can have a high tensile strength.

### Means to Solve the Problem

An electric wire with a terminal according to the present disclosure is an electric wire with a terminal to which the electric wire is joined, and includes: a terminal including a wire joint portion; and the electric wire joined to the wire joint portion, wherein a first surface and a second surface located at different heights are formed at different positions in a width direction on a surface of the wire joint portion facing the electric wire, and the electric wire is joined to the first surface, the second surface, and at least a portion of a region between the first surface and the second surface of the wire joint portion.

### Effect of the Invention

According to the present disclosure, an electric wire with a terminal that can have a high tensile strength is provided.

### BRIEF DESCRIPTION OF THE DRAWINGS

FIG. 1 is a perspective view showing an electric wire with a terminal according to a first embodiment.

FIG. 2 is a perspective view showing a terminal constituting the electric wire with a terminal.

FIG. 3 is a perspective view showing an electric wire constituting the electric wire with a terminal.

FIG. 4 is a cross-sectional view showing a cross section taken along a line IV-IV in FIG. 1.

FIG. 5 is a diagram showing a state of joining between the terminal and the electric wire.

FIG. 6 is a cross-sectional view showing a cross section of an electric wire with a terminal of a comparative example, corresponding to FIG. 4.

FIG. 7 is a diagram showing a comparison between the tensile strength of the electric wire with a terminal according to the first embodiment and the tensile strength of the electric wire with a terminal of the comparative example.

FIG. 8 is a cross-sectional view showing a cross section of an electric wire with a terminal of a second embodiment, corresponding to FIG. 4.

FIG. 9 is a cross-sectional view showing a cross section of an electric wire with a terminal of a third embodiment, corresponding to FIG. 4.

FIG. 10 is a cross-sectional view showing a cross section of an electric wire with a terminal of a fourth embodiment, corresponding to FIG. 4.

### DETAILED DESCRIPTION TO EXECUTE THE INVENTION

### Description of Embodiments of Present Disclosure

First, embodiments of the present disclosure will be listed and described.

An electric wire with a terminal according to the present disclosure is as follows.

(1) An electric wire with a terminal to which the electric wire is joined, including: a terminal including a wire joint portion; and the electric wire joined to the wire joint portion, wherein a first surface and a second surface located at different heights are formed at different positions in a width direction on a surface of the wire joint portion facing the electric wire, and the electric wire is joined to the first surface, the second surface, and at least a portion of a region between the first surface and the second surface of the wire joint portion. With this configuration, a joined portion extending in the height direction is formed in the terminal, and this increases the joined area between the terminal and the electric wire. The increase in the joined area results in an increase in the joining strength. Therefore, the tensile strength can be increased.

If there is a portion in which the wire joint portion and the electric wire are not joined, a total width that is a sum of the width of the first surface, the width of the second surface, and the width of the portion of the region to which the electric wire is joined between the first surface and the second surface is preferably larger than the width of the wire joint portion in a plan view.

(2) In the electric wire with a terminal according to (1), the wire joint portion and the electric wire may respectively include portions that have the same size in the width direction in the wire joint portion. With this configuration, it is possible to make the joined portion between the terminal and the electric wire larger in the width direction of the wire joint portion.

(3) In the electric wire with a terminal according to (1) or (2), the wire joint portion may include a base portion and a wall portion protruding from an end portion in the width direction of the base portion, the first surface may be a main surface of the base portion, and the second surface may be a distal end surface of the wall portion. In this case, the joined area is increased by a side surface of the wall portion, compared with a wire joint portion that does not include the wall portion. Therefore, the tensile strength can be increased.

(4) In the electric wire with a terminal according to (3), a pair of the wall portions may be respectively formed at two end portions in the width direction of the base portion, and the second surface may be formed at a distal end surface of each of the pair of wall portions. In this case, the joined area is increased by side surfaces of the pair of wall portions. Also, the pair of wall portions are located at the two ends of the first surface, and accordingly, when the electric wire is joined to the wire joint portion, the electric wire is placed on the first surface that is formed at the center, and therefore, it is easy to join the electric wire to the wire joint portion.

(5) In the electric wire with a terminal according to any one of (1) to (4), the electric wire may be joined to the wire joint portion via a resistance welding portion formed by resistance welding or an ultrasonic joining portion formed by ultrasonic joining.

(6) In the electric wire with a terminal according to (5), the electric wire may be joined to the wire joint portion via the resistance welding portion, and a core wire of the electric wire or the wire joint portion may be plated with Sn. Sn plating makes it possible to perform the resistance welding favorably.

(7) In the electric wire with a terminal according to (5), the terminal may be made of copper or a copper alloy, and the electric wire may include a core wire made of copper or a copper alloy. In this case, contact corrosion between different types of metals is suppressed.

(8) In the electric wire with a terminal according to any one of (1) to (7), the electric wire may be a twisted wire. In this case, the electric wire deforms more easily compared with a case where the electric wire is a single core wire. Therefore, the electric wire easily deforms into a shape that conforms to the shape of the wire joint portion, and it is possible to increase the area of contact between the electric wire and the wire joint portion.

### DETAILS OF EMBODIMENTS OF PRESENT DISCLOSURE

### First Embodiment

Specific examples of an electric wire with a terminal according to the present disclosure will be described with reference to the drawings referred to below. Note that the present disclosure is not limited to the following examples, but is defined by the claims, and is intended to encompass all modifications within the meanings and scope that are equivalent to the claims.

The following describes an electric wire with a terminal according to the present disclosure.

(Electric Wire 1 with Terminal)

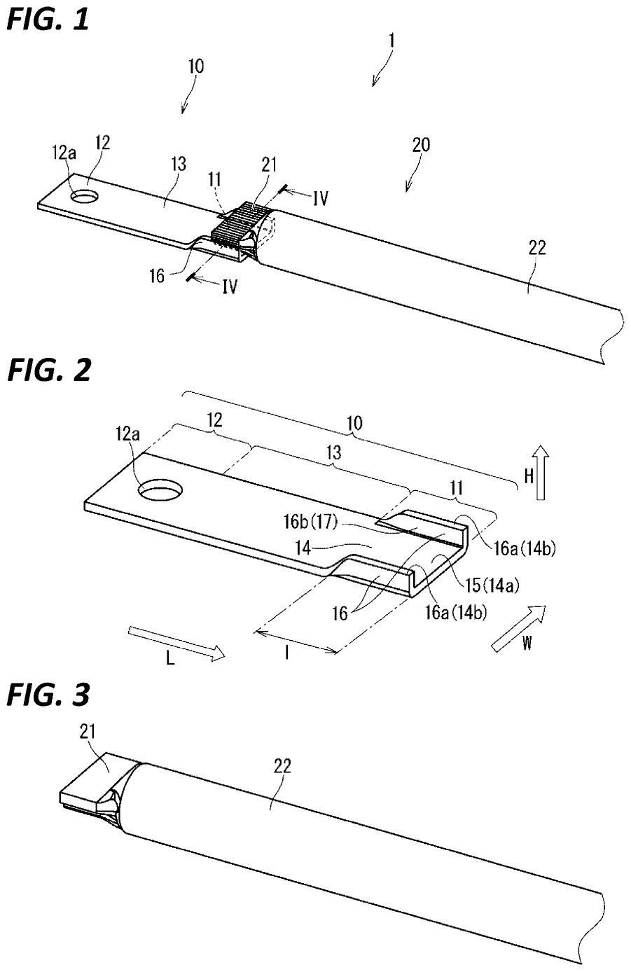

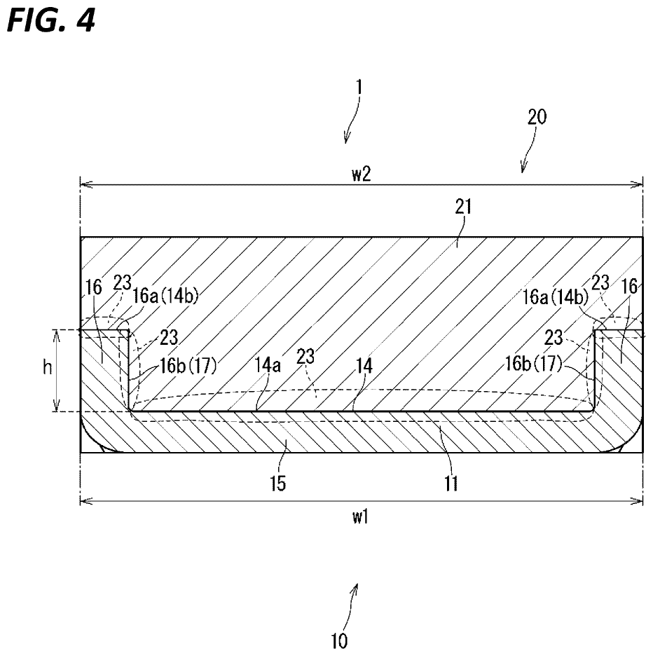

The following describes an overview of the structure of an electric wire with a terminal according to a first embodiment. FIG. 1 is a perspective view showing an electric wire 1 with a terminal according to the first embodiment of the present disclosure. FIG. 2 is a perspective view showing a terminal 10 constituting the electric wire 1 with a terminal. FIG. 3 is a perspective view showing an electric wire 20 constituting the electric wire 1 with a terminal. FIG. 4 is a cross-sectional view showing a cross section taken along the line IV-IV in FIG. 1. Note that the term “surface” used in the present embodiment is not limited to a flat surface but also encompasses a curved surface. Note that FIG. 1 shows conductive wires constituting a twisted wire in a leading end portion of a core wire 21, but illustration of the conductive wires is omitted in the other drawings.

The electric wire 1 with a terminal includes the terminal 10 and the electric wire 20 joined to the terminal 10. The electric wire 20 includes the core wire 21 and a covering 22 that covers the core wire 21. The core wire 21 is made of a material including copper or a copper alloy, for example. The core wire 21 in the present embodiment is a twisted wire, for example. The core wire 21 is plated with Sn, for example. The covering 22 is formed using a material having insulating properties, for example. Note that the present embodiment is applicable not only to a twisted wire but also to a single core wire. When it is desired to secure predetermined strength of the core wire 21, a single core wire is used, rather than a twisted wire. However, a twisted wire is easy to deform with a relatively small pressure. Accordingly, a twisted wire more easily conforms to the shape of a joint portion of the terminal 10 when it is joined to the terminal 10.

As shown in FIG. 4, in a wire joint portion 11, which will be described later in detail, there is a portion in which a size w1 of the wire joint portion 11 in a width direction is the same as a size w2 of the electric wire 20 in the width direction. Note that the core wire 21 is joined to the wire joint portion 11. Although the configuration in which the size w1 is the same as the size w2 is adopted in the present embodiment, there is no limitation to this configuration. The size w1 may be different from the size w2.

### (Terminal 10)

The terminal 10 includes the wire joint portion 11 to which the electric wire 20 is joined, an electrical contact portion 12 that is electrically connected to a component to which the electric wire is connected, and a coupling portion 13 that couples the wire joint portion 11 and the electrical contact portion 12. The wire joint portion 11, the electrical contact portion 12, and the coupling portion 13 are connected in a length direction L. The terminal 10 is constituted by a plate-shaped member subjected to pressing, for example. The terminal 10 is made of a material including copper or a copper alloy, for example. The terminal 10 is plated with Sn, for example. From the viewpoint of suppressing contact corrosion between different types of metals, the material of the wire joint portion 11 of the terminal 10 is preferably of the same type as the material of the core wire 21.

The wire joint portion 11 has a surface 14 that faces the electric wire 20 (the core wire 21). A first surface 14a and second surfaces 14b are formed in the surface 14. The first surface 14a and the second surfaces 14b are formed at different positions on the wire joint portion 11 in the width direction W. The first surface 14a and the second surfaces 14b are located at different heights in a height direction H. Here, the height direction H is a direction that is perpendicular to the width direction W and the length direction L. The height direction H may be the direction in which the core wire 21 is stacked on the wire joint portion 11 or the direction in which a pressure is applied when the electric wire is jointed to the terminal.

In the present embodiment, two end portions of the plate-shaped portion are bent upward so as to extend along the height direction H. Wall portions 16 are respectively formed at two end portions of the wire joint portion 11 in the width direction W. The wall portions 16 are formed by bending the two end portions of the wire joint portion 11 in the width direction W. That is to say, the wire joint portion 11 includes a plate-shaped base portion 15 and the pair of wall portions 16 located at two ends of the base portion 15. The wall portions 16 are bent so as to be orthogonal to the base portion 15. The wall portions 16 may form an obtuse angle or an acute angle with respect to the base portion 15. The first surface 14a of the wire joint portion 11 is a main surface of the base portion 15 (a portion that is not bent). Also, the second surfaces 14b of the wire joint portion 11 are distal end surfaces 16a of the wall portions 16 located at two end portions of the first surface 14a (the base portion 15) in the width direction W. The distal end surfaces 16a are portions corresponding to side surfaces of the plate-shaped member prior to being bent. In the present embodiment, the distal end surfaces 16a (the second surfaces 14b) formed at the two end portions are located at the same height. Note that the distal end surfaces 16a (the second surfaces 14b) may be located at different heights.

The surface 14 further includes regions 17 (rising surfaces 16b of the wall portions 16) between the first surface 14a on the base portion 15 and the distal end surfaces 16a (the second surfaces 14b). The core wire 21 is joined to at least a portion of the regions 17 (the rising surfaces 16b). In the present embodiment, resistance welding portions 23 are formed between the first surface 14a of the base portion 15 and the core wire 21, between the two distal end surfaces 16a (the second surfaces 14b) and the core wire 21, and between the regions 17 (the rising surfaces 16b) and the core wire 21. In the present embodiment, the surface 14 and the core wire 21 are continuously joined with no gap formed between the surface 14 and the core wire 21. A total width of joining between the core wire 21 and the first surface 14a, the two distal end surfaces 16a, and the two regions 17 is a sum of the width of the first surface 14a, the widths of the two distal end surfaces 16a, and rising lengths of the two regions 17. However, a gap may be formed between the surface 14 of the terminal 10 and the core wire 21. The gap may be formed at corners between the first surface 14a and the rising surfaces 16b, for example. Even if a gap is formed, the total width of joining between the core wire 21 and the first surface 14a, the two distal end surfaces 16a, and the two regions 17 is preferably larger than the width of the wire joint portion 11. Note that the total width of joining between the core wire 21 and the first surface 14a, the two distal end surfaces 16a, and the two regions 17 is a length obtained by subtracting a length corresponding to the gap from the sum of the width of the first surface 14a, the widths of the two distal end surfaces 16a, and the rising lengths of the two regions 17.

The electrical contact portion 12 and the coupling portion 13 are plate-shaped. The electrical contact portion 12 has a through hole 12a (see FIGS. 1 and 2) through which a fixing member for fixing the terminal 10 to the component to which the electric wire 20 is connected extends. Examples of the fixing member include a screw and a bolt. In the present embodiment, a fixing member such as a screw and a bolt is described as an example of a fixing structure for fixing the terminal 10 to the component to which the electric wire 20 is connected, but there is no limitation to this configuration. It is possible to adopt another fixing structure realized by, for example, bonding or welding, or a fitting structure as the fixing structure for fixing the terminal 10 to the component to which the electric wire 20 is connected.

### (Joining Between Terminal 10 and Electric Wire 20)

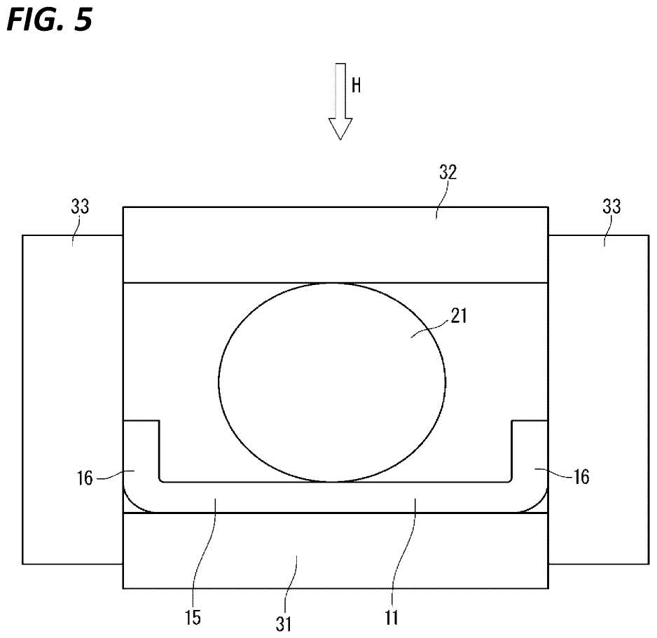

FIG. 5 is a diagram showing a state of joining between the terminal 10 and the electric wire 20.

In the present embodiment, the core wire 21 of the electric wire 20 is joined to the wire joint portion 11 via the resistance welding portions 23. The resistance welding portions 23 are formed by resistance welding in portions where the core wire 21 is joined to the wire joint portion 11. In the present embodiment, a configuration in which the core wire 21 is joined to the wire joint portion 11 via the resistance welding portions 23 is adopted, but there is no limitation to this configuration. The core wire 21 may be joined to the wire joint portion 11 via a crimped portion formed by crimping, an ultrasonic joining portion formed by ultrasonic joining, a soldered portion formed by soldering, or the like, instead of the resistance welding portions 23.

As shown in FIG. 5, a resistance welding machine 30 includes a lower electrode 31, an upper electrode 32, and side guide members 33. The lower electrode 31 may be a cathode electrode, and the upper electrode 32 may be an anode electrode. The side guide members 33 are formed using a ceramic material having insulating properties, for example. The side guide members 33 support outer side surfaces of the wall portions 16 from opposite sides. Support surfaces of the side guide members 33 extend to positions above the wall portions 16. Therefore, it is possible to prevent the core wire 21 from spreading outward past the wire joint portion 11 with the support surfaces of the side guide members 33 at the time of resistance welding. By performing the resistance welding with use of the side guide members 33 provided on the opposite sides, it is possible to realize the configuration including a portion where the size w1 of the wire joint portion 11 in the width direction is the same as the size w2 of the electric wire 20 in the width direction.

The upper electrode 32 is movable in the height direction H. At the time of welding, the upper electrode 32 moves toward the lower electrode 31.

In the resistance welding for joining the terminal 10 and the electric wire 20, first, the terminal 10 is placed on the lower electrode 31. At this time, the terminal 10 is disposed so as to be sandwiched between the side guide members 33. Next, the electric wire 20 (the core wire 21) is placed on the wire joint portion 11 of the terminal 10. Thus, the wire joint portion 11 and the core wire 21 are disposed between the lower electrode 31 and the upper electrode 32. Then, the upper electrode 32 moves toward the lower electrode 31, and the lower electrode 31 and the upper electrode 32 press the wire joint portion 11 and the core wire 21. At the same time as the application of a pressure, electricity is passed through the lower electrode 31 and the upper electrode 32 to heat the wire joint portion 11 and the core wire 21. The core wire 21 is pressed against the wire joint portion 11 with the pressure, and the core wire 21 deforms along the shape of a leading end surface of the wire joint portion 11. Thus, the core wire 21 is pressed against the first surface 14a and the two second surfaces 14b, as well as against the rising surfaces 16b, and is welded to the portions of the wire joint portion 11 to which the core wire is pressed.

At this time, the core wire 21 is restricted from spreading outward past the wire joint portion 11, and accordingly, two side surfaces of the core wire 21 coincide with two side surfaces of the wire joint portion 11.

Thereafter, the upper electrode 32 moves away from the lower electrode 31 and returns to its initial position. Then, the electric wire 1 with a terminal obtained by joining the electric wire 20 to the terminal 10 is taken out from the resistance welding machine. Note that the order of the above-described steps can be changed as appropriate.

### Comparison with Conventional Technology

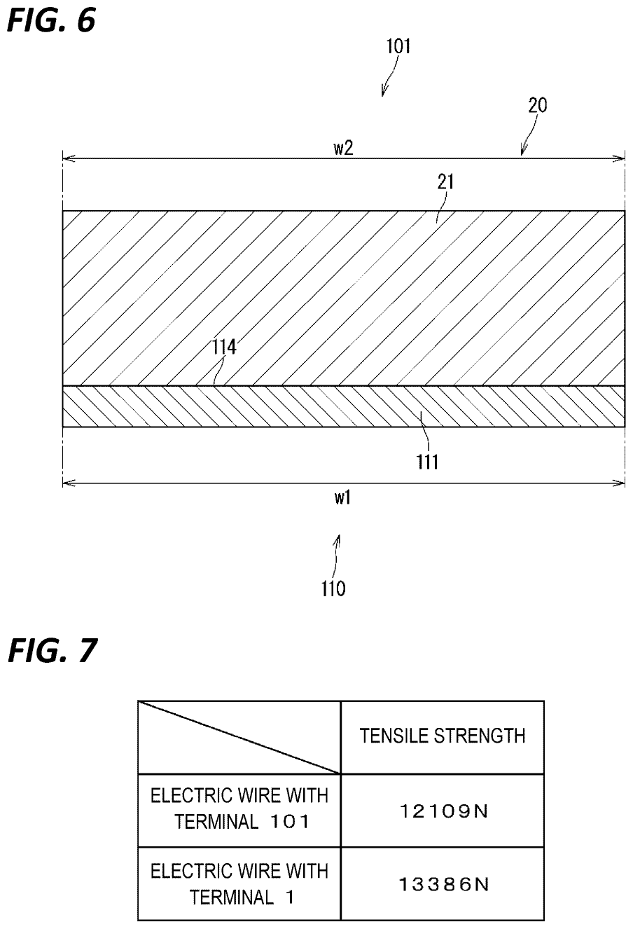

FIG. 6 is a cross-sectional view showing a cross section of an electric wire 101 with a terminal of a comparative example, corresponding to FIG. 4. FIG. 7 is a diagram showing a comparison between the tensile strength of the electric wire 1 with a terminal according to the present embodiment and the tensile strength of the electric wire 101 with a terminal of the comparative example.

A wire joint portion 111 of a terminal 110 included in the electric wire 101 with a terminal does not have the rising surfaces 16b in the present embodiment. That is to say, the wire joint portion 111 does not include the wall portions 16 in the present embodiment, and a surface 114 of the wire joint portion 111 facing the electric wire 20 is a flush surface.

The following describes tensile strengths of the electric wire 20 with respect to the terminals 10 and 110 by comparing the electric wire 1 with a terminal according to the present embodiment and the electric wire 101 with a terminal of the comparative example, assuming that the terminal 10 of the present embodiment and the terminal 110 of the comparative example have a plate thickness of 1.5 mm, the size w1 in the width direction (see FIGS. 4 and 6) of 17.5 mm, and the wire joint portions 11 and 111 have a length of 9.0 mm. Note that a height h (see FIG. 4) from the surface 14 of the terminal 10 to the distal end surfaces 16a is assumed to be 3 mm. The core wire 21 is assumed to have a cross-sectional area of 70 mm².

As shown in FIG. 7, the tensile strength of the electric wire 101 with a terminal is 12109 [N], whereas the tensile strength of the electric wire 1 with a terminal is 13386 [N]. That is to say, the electric wire 1 with a terminal according to the present embodiment has a strength approximately 10% higher (13386 [N]/12109 [N]×100≈110 [%]) than that of the electric wire 101 with a terminal of the comparative example. It is thought that this is because the joined area in the electric wire 1 with a terminal according to the present embodiment is increased by the regions 17 (the rising surfaces 16b of the wall portions 16) between the first surface 14a and the distal end surfaces 16a (the second surfaces 14b).

### Effects of First Embodiment

The electric wire 1 with a terminal configured as described above is the electric wire 1 with a terminal to which the electric wire 20 is joined, and includes: the terminal 10 including the wire joint portion 11; and the electric wire 20 joined to the wire joint portion 11, wherein the first surface 14a and the second surfaces 14b located at different heights are formed at different positions in the width direction W on the surface 14 of the wire joint portion 11 facing the electric wire 20, and the electric wire 20 is joined to the first surface 14a, the second surfaces 14b, and at least a portion of the regions 17 between the first surface 14a and the second surfaces 14b of the wire joint portion 11. With this configuration, a joined portion is formed in the terminal 10 along the height direction H as well, and this increases the joined area between the terminal 10 and the electric wire 20. The increase in the joined area results in an increase in the joining strength. Therefore, the electric wire 1 with a terminal according to the present embodiment can have a high tensile strength.

Also, in the wire joint portion 11, the size w1 of the wire joint portion 11 in the width direction W is the same as the size w2 of the electric wire in the width direction. Therefore, a joined portion between the terminal 10 and the electric wire 20 can be made as large as possible in the width direction of the wire joint portion 11.

Also, the first surface 14a of the wire joint portion 11 is the main surface of the base portion 15, and the second surfaces 14b of the wire joint portion 11 are the distal end surfaces 16a of the wall portions 16 formed at two end portions of the first surface 14a in the width direction W. Accordingly, the joined area is increased by the rising surfaces 16b of the wall portions 16, when compared with a case where the wall portions 16 are not formed. Also, the wall portions 16 are located at the two ends of the first surface 14a, and accordingly, when the electric wire 20 is joined to the wire joint portion 11, the electric wire 20 is placed on the first surface 14a that is formed at the center, and therefore, it is easy to join the electric wire 20 to the wire joint portion 11.

Also, the electric wire 20 is joined to the wire joint portion 11 via the resistance welding portions 23 formed by resistance welding. Also, the core wire 21 of the electric wire 20 and the wire joint portion 11 are plated with Sn. Therefore, it is expected that the resistance welding between the wire joint portion 11 and the core wire 21 is facilitated by the influence of an intermetallic compound formed by Sn plating.

Moreover, if the terminal 10 is made of copper or a copper alloy, and the core wire 21 of the electric wire 20 is made of copper or a copper alloy, the terminal 10 and the electric wire 20 are made of the same type of metal. Therefore, contact corrosion between different types of metals, which is caused by contact between two types of metals, is suppressed.

Also, if the core wire 21 of the electric wire 20 is a twisted wire, the core wire deforms more easily compared with a case where the core wire is a single core wire. Therefore, the electric wire 20 easily deforms into a shape that conforms to the shape of the wire joint portion 11, and it is possible to increase the area of contact between the electric wire 20 and the wire joint portion 11.

Note that, as disclosed in Patent Document 1, there are cases where a joint portion for joining a terminal fitting and a core wire is formed such that two ends of the joint portion in the width direction are located higher than a bottom surface of the joint portion, but this configuration aims to prevent the electric wire from spreading outward past the two ends. Accordingly, it is thought that enlarging the joined portion between the core wire 21 and the terminal by using the wall portions 16 formed at the two ends in the width direction W as in the electric wire 1 with a terminal according to the present invention is an idea that has not been conceived.

### Second Embodiment

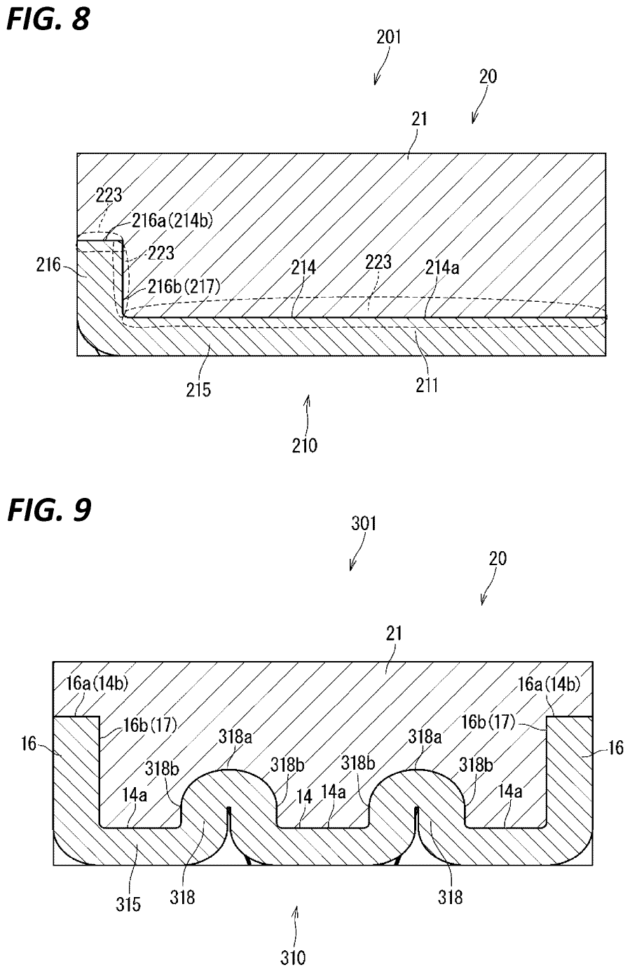

FIG. 8 is a cross-sectional view showing a cross section of an electric wire 201 with a terminal according to a second embodiment, corresponding to FIG. 4.

The electric wire 201 with a terminal according to the second embodiment includes a terminal 210 instead of the terminal 10 in the first embodiment. An end portion on one side of the terminal 210 is bent upward along the height direction H. Thus, a wall portion 216 is formed at an end portion of a wire joint portion 211 on the one side in the width direction W. The wire joint portion of the second embodiment has the same configuration as the wire joint portion 11 of the first embodiment described above, except for the wall portion 216 (i.e., other than that the wall portion is omitted on the other side in the width direction). A surface 214 of the wire joint portion 211 facing the electric wire 20 includes a second surface 214b that is a distal end surface of the bent wall portion 216 and a portion other than the wall portion 216 (a first surface 214a that is a main surface of a base portion 215).

### Effects of Second Embodiment

In the present embodiment, resistance welding portions 223 are formed between the first surface 214a of the base portion 215 and the core wire 21, between the distal end surface 216a (the second surface 214b) and the core wire 21, and between a region 217 (a rising surface 216b) and the core wire 21. When compared with the comparative example (see FIG. 6) described above, the joined area in the second embodiment is increased by a joined portion between the core wire 21 and the region 217 (the rising surface 216b) corresponding to the wall portion 16 on the one side. Therefore, the electric wire 201 with a terminal according to the second embodiment can also have a high tensile strength.

### Third Embodiment

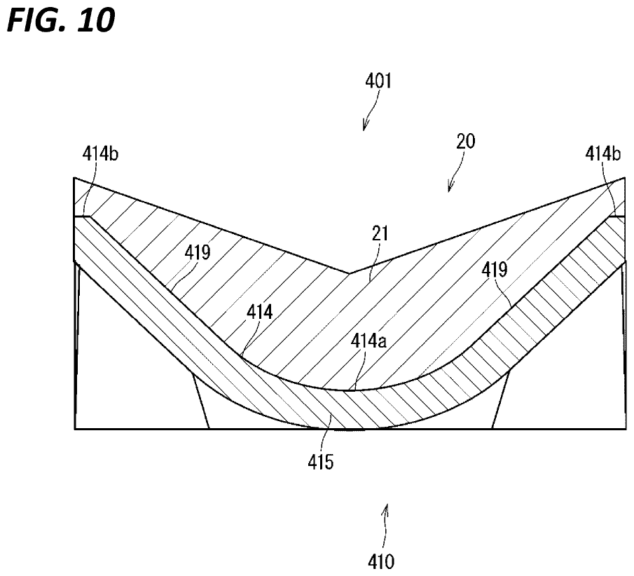

FIG. 9 is a cross-sectional view showing a cross section of an electric wire 301 with a terminal according to a third embodiment, corresponding to FIG. 4.

The electric wire 301 with a terminal according to the third embodiment includes a terminal 310 instead of the terminal 10 in the first embodiment. This electric wire with a terminal includes two mountain portions 318 in a base portion 315 between the wall portions 16 provided at the two ends. A main surface between the mountain portions 318 is the first surface 14a, and peak portions of the mountain portions are other second surfaces 318a located at a height different from the height of the first surface 14a. Regions 318b between the first surface 14a and the second surfaces 318a are rising surfaces of the mountain portions 318.

In the third embodiment, the electric wire 20 is joined to the first surface 14a, the second surfaces 14b and 318a, and the regions 17 and 318b between the first surface 14a and the second surfaces 14b and 318a. In the third embodiment, the regions 318b, which are rising portions of the mountain portions 318, are also included in the joined portion in addition to the joined portion in the first embodiment. Therefore, the joined area in the electric wire 301 with a terminal according to the third embodiment is increased by the joined portion between the core wire 21 and the regions 318b, compared with the electric wire 1 with a terminal according to the first embodiment. Therefore, the electric wire 301 with a terminal according to the third embodiment can also have a high tensile strength.

### Fourth Embodiment

FIG. 10 is a cross-sectional view showing a cross section of an electric wire 401 with a terminal according to a fourth embodiment, corresponding to FIG. 4.

The electric wire 401 with a terminal according to the fourth embodiment includes a terminal 410 instead of the terminal 10 in the first embodiment. A first surface 414a is formed at the center of a surface 414, and second surfaces 414b that are located at a height different from the height of the first surface 414a are formed at two ends of the surface 414. The second surfaces 414b are higher than the first surface 414a. Regions 419 between the first surface 414a and the second surfaces 414b are rising surfaces rising to the second surfaces 414b.

In the present embodiment, the core wire 21 of the electric wire 20 is joined to the first surface 414a, the second surfaces 414b, and the regions 419. The rising surfaces in the first through third embodiments are steep, but the rising surfaces 419 in the fourth embodiment are gentler than the rising surfaces in the first through third embodiments. Accordingly, the core wire 21 is more likely to be formed into a shape that conforms to the rising surfaces. That is to say, the core wire 21 comes into contact with a large area of the regions 419. Also, it is easy to press the core wire 21 against the gentle rising surfaces to join the core wire.

Moreover, in the electric wire 401 with a terminal according to the fourth embodiment, the regions 419 slope, and this increases the joined area of the core wire 21 compared with the flat surface 14 like that in the comparative example. Therefore, the electric wire 401 with a terminal according to the fourth embodiment can also have a high tensile strength.

### Variation

In the above embodiments, the core wire 21 and the terminals 10, 210, 310, and 410 are joined via the resistance welding portions 23, but there is no limitation to this configuration. The core wire and the terminals may be joined by other joining methods such as crimping, ultrasonic joining, soldering, or the like.

The configurations described in the above embodiments and variation can be combined as appropriate as long as there is no contradiction between them.

### List of Reference Numerals

1, 101, 201, 301, 401 Electric wire with terminal
10, 110, 210, 310, 410 Terminal
11, 111, 211 Wire joint portion
12 Electrical contact portion
12a Through hole
13 Coupling portion
14, 114,214 Surface
14a, 214a, 414a First surface
14b, 214b, 318a, 414b Second surface
15, 215, 415 Base portion
16, 216 Wall portion
16a, 216a Distal end surface
16b, 216b Rising surface
17, 217, 318b, 419 Region
20 Electric wire
21 Core wire
22 Covering
23, 223 Resistance welding portion
30 Resistance welding machine
31 Lower electrode
32 Upper electrode
33 Side guide member
318 Mountain portion
H Height direction
L Direction
W Width direction
h Height

1. An electric wire with a terminal to which the electric wire is joined, comprising:
a terminal including a wire joint portion; and
the electric wire joined to the wire joint portion,
wherein a first surface and a second surface located at different heights are formed at different positions in a width direction on a surface of the wire joint portion facing the electric wire,
the electric wire is joined to the first surface, the second surface, and at least a portion of a region between the first surface and the second surface of the wire joint portion,
the wire joint portion and the electric wire respectively include portions that have the same size in the width direction in the wire joint portion,
the first surface is formed at the center in the width direction of the wire joint portion,
a pair of the second surfaces located higher than the first surface are formed at two ends in the width direction of the wire joint portion, and
a pair of rising surfaces are formed in the wire joint portion so as to extend from the first surface toward the pair of second surfaces, gradually making the wire joint portion wider.

2. (canceled)

3. An electric wire with a terminal to which the electric wire is joined, comprising:
a terminal including a wire joint portion; and
the electric wire joined to the wire joint portion,
wherein a first surface and a second surface located at different heights are formed at different positions in a width direction on a surface of the wire joint portion facing the electric wire,
the electric wire is joined to the first surface, the second surface, and at least a portion of a region between the first surface and the second surface of the wire joint portion,
the wire joint portion includes a base portion and a wall portion protruding from an end portion in the width direction of the base portion,
the first surface is a main surface of the base portion,
the second surface is a distal end surface of the wall portion, and
the wire joint portion includes a pair of the wall portions protruding from two end portions in the width direction of the base portion, the wall portions being formed by bending two end portions of a plate-shaped portion.

4. The electric wire with a terminal according to claim 3,
wherein a pair of the wall portions are respectively formed at two end portions in the width direction of the base portion, and
the second surface is formed at a distal end surface of each of the pair of wall portions.

5. The electric wire with a terminal according to claim 1,
wherein the electric wire is joined to the wire joint portion via a resistance welding portion formed by resistance welding or an ultrasonic joining portion formed by ultrasonic joining.

6. The electric wire with a terminal according to claim 5,
wherein the electric wire is joined to the wire joint portion via the resistance welding portion, and
a core wire of the electric wire or the wire joint portion is plated with Sn.

7. The electric wire with a terminal according to claim 5,
wherein the terminal is made of copper or a copper alloy, and
the electric wire includes a core wire made of copper or a copper alloy.

8. The electric wire with a terminal according to claim 1,
wherein the electric wire includes a twisted wire.
